(19) United States
(12) Patent Application Publication
(10) Pub. No.: US 2022/0352767 A1
(43) Pub. Date: Nov. 3, 2022

(54) STATOR AND ROTATING ELECTRICAL MACHINE, AND MANUFACTURING METHOD FOR THEM

(71) Applicant: Mitsubishi Electric Corporation, Chiyoda-ku, Tokyo (JP)

(72) Inventors: Takayuki TAKESHITA, Tokyo (JP); Takeshi YAGI, Tokyo (JP); Taichi TOKUHISA, Tokyo (JP); Shinri MATSUKAWA, Tokyo (JP); Yutaka HIROTA, Tokyo (JP); Hidenori MIYAMOTO, Tokyo (JP)

(73) Assignee: Mitsubishi Electric Corporation, Chiyoda-ku, Tokyo (JP)

(21) Appl. No.: 17/619,028

(22) PCT Filed: Jul. 28, 2020
(86) PCT No.: PCT/JP2020/028803

§ 371 Date: Dec. 14, 2021

(30) Foreign Application Priority Data
Aug. 20, 2019 (JP) 2019-150106

(51) Int. Cl. H02K 1/14; H02K 15/10; H02K 15/02

(52) U.S. Cl. CPC H02K 1/148; H02K 15/10; H02K 15/022

(57) ABSTRACT

A stator has a plurality of core pieces being arranged in a ring shape around a rotation axis, and is configured such that a coupling part having a fitting structure is formed between the core pieces adjacent to each other in an arrangement of the ring shape, the coupling part allowing rotation about a pillar portion and restricting displacement in the axis direction by a snap-fit coupling that is formed with the pillar portion being provided on the yoke side of one of the core pieces and extending in a direction parallel to the axis and an open ring portion being provided on the yoke side of the other of the core pieces.

### TECHNICAL FIELD

The present application relates to a stator, a rotating electrical machine, and a manufacturing method for them.

### BACKGROUND ART

In a stator of a rotating electrical machine, a structure in which core pieces (sometimes referred to as a divided core) divided in an unit of tooth basis are folded freely in a direction perpendicular to a rotation axis to be connected to each other is disclosed (see, for example, Patent Documents 1 and 2). Although adjacent teeth in the stator are close to each other on the inner side in the radial direction, because of the structure described above, by changing the angle of a connecting portion such that the teeth are positioned outward in the radial direction, winding can be performed without interfering with adjacent core pieces, and the space factor of a coil can be improved.

### CITATION LIST

### Patent Document

Patent Document 1: Japanese Patent Application Laid-open No. 2000-201458 (Paragraphs 0032 to 0036, FIG. 1 to FIG. 5)
Patent Document 2: Japanese Patent Application Laid-open No. 2006-254569 (Paragraphs 0045 to 0051, FIG. 5 to FIG. 8)

### SUMMARY OF INVENTION

### Problems to be Solved by Invention

However, in Patent Document 1, since the laminated steel sheets of adjacent core pieces are to be engaged with each other at a connecting portion, it is necessary to prepare two types of the laminated steel sheets and punched caulking for connecting the portions is necessary, and thus there is a problem that the number of types of members is increased and the process is complicated. In addition, in Patent Document 2, a mechanism for extracting or inserting the core pieces in the axis direction is provided for the connection and the rotation, but it is necessary to provide a holding mechanism or the like in order to prevent positional shift in the axis direction when the teeth are directed outward after the connection, and thus there is a problem in that the manufacturing process is complicated.

The present application discloses a technology to overcome the problems described above and an object thereof is to obtain a stator and a rotating electrical machine having high performance without increasing the number of parts and the manufacturing processes.

### Means for Solving Problems

A stator is characterized in that a plurality of core pieces each of which includes a magnetic material part in which a yoke extending in an arc shape and a tooth protruding from the yoke toward a rotation axis are formed, and a coil wound around the tooth, the plurality of core pieces being arranged in a ring shape around the axis, wherein a coupling part having a fitting structure is formed between the core pieces adjacent to each other in an arrangement of the ring shape, the coupling part allowing rotation about a pillar portion and restricting displacement in the axis direction by a snap-fit coupling that is formed with the pillar portion being provided on the yoke side of one of the core pieces and extending in a direction parallel to the axis and an open ring portion being provided on the yoke side of other of the core pieces, the open ring portion is provided with a gap between the open ring portion and the magnetic material part in the axis direction, the pillar portion is provided so as to extend from a base portion having a larger diameter than the pillar portion, and the base portion of the one of the core pieces is inserted into the gap of the other of the core pieces when the snap-fit coupling is formed.

A manufacturing method for the stator disclosed in the present application is characterized by including a step of forming each of a plurality of core piece members by covering the magnetic material part with insulators, the magnetic material part being formed such that the yoke extending in an arc shape and the tooth protruding from the yoke toward the axis are formed, a step of forming the coupling part having the fitting structure between the core piece members adjacent to each other in arranging a plurality of the core piece members such that the teeth are directed to the same side and end faces of the yokes in the circumferential direction are arranged to face each other, the coupling part allowing rotation about the pillar portion and restricting displacement in the axis direction by the snap-fit coupling in which the pillar portion being provided with a gap between the open ring portion and the magnetic material part in the axis direction in a yoke part of one of the core piece members and extending in the direction parallel to the axis is fitted into the open ring portion being provided in the yoke part of other of the core piece members, a step of forming the coil by winding a wire around each tooth in each of a plurality of the core piece members connected by the coupling part with an angle between the teeth of the core piece members adjacent to each other widened, and a step of connecting the core piece members having the coils formed thereon in the ring shape with the teeth directed inward, wherein the pillar portion is provided so as to extend from a base portion having a larger diameter than the pillar portion, and the base portion of one of the core piece members is inserted into the gap of the other of the core piece members when the snap-fit coupling is formed.

Another manufacturing method for the stator disclosed in the present application is characterized by including a step of forming each of a plurality of the core piece members by covering the magnetic material part with the insulators, the magnetic material part being formed such that the yoke extending in an arc shape and the tooth protruding from the yoke toward the axis are formed, a step of forming the coil by winding the wire around each tooth in each of a plurality of the core piece members, and a step of connecting the core piece members in the ring shape with the teeth directed inward after forming the coupling part having the fitting structure between the core piece members adjacent to each other in arranging a plurality of the core piece members having the coils formed thereon such that the teeth are directed to the same side and the end faces of the yokes in the circumferential direction are arranged to face each other, the coupling part allowing the rotation about the pillar portion and restricting the displacement in the axis direction by the snap-fit coupling in which the pillar portion being provided with a gap between the open ring portion and the magnetic material part in the axis direction in the yoke part of one of the core piece members and extending in the direction parallel to the axis is fitted into the open ring portion being provided in the yoke part of other of the core piece members, wherein the pillar portion is provided so as to extend from a base portion having a larger diameter than the pillar portion, and the base portion of one of the core piece members is inserted into the gap of the other of the core piece members when the snap-fit coupling is formed.

### Effect of Invention

According to the stator or the manufacturing method for the stator disclosed in the present application, the stator and the rotating electrical machine with high performance can be obtained without increasing the number of parts and the manufacturing processes because the coupling part which is rotatable by the snap-fit coupling and restricts the displacement in the axis direction is formed.

### BRIEF DESCRIPTION OF DRAWINGS

FIG. 1 is a plan view showing an appearance of a stator before molding according to Embodiment 1.

FIG. 2 is a perspective view showing an appearance of a core piece constituting the stator according to Embodiment 1.

FIG. 3 is a perspective view showing an appearance of a magnetic material part constituting the core piece of the stator according to Embodiment 1.

FIG. 4 is a perspective view showing an appearance of an insulator constituting the core piece of the stator according to Embodiment 1.

FIG. 5 is a side view showing an appearance of a core piece member having the insulator mounted on the magnetic material part of the stator as viewed from an outer peripheral side according to Embodiment 1.

FIG. 6 is a cross-sectional view of the core piece member constituting the core piece of the stator in a plane parallel to a rotation axis direction and a radial direction according to Embodiment 1.

FIG. 7 is a plan view showing an appearance of the core piece of the stator according to Embodiment 1.

FIG. 8 is a plan view showing a state in which core piece members of the stator according to Embodiment 1 are connected to each other.

FIG. 9 is a flowchart showing a manufacturing method for the stator according to Embodiment 1.

FIG. 10 is a plan view showing a state in which core piece members constituting the stator according to Embodiment 1 are connected for winding.

FIG. 11A, FIG. 11B, and FIG. 11C are schematic plan views showing states before and after a wire is wound around each of the core piece members that are connected, and a schematic plan view showing a state after the wire is wound around the core piece member that is not connected, when the stator is to be manufactured according to Embodiment 1.

FIG. 12 is a schematic cross-sectional view in a plane including the axis in order to show a difference in shape in each of the cases where a rotating electrical machine that is formed with a stator using the magnetic material part by powder compacting, which is exemplified in Embodiment 1, and a rotating electrical machine that formed with a stator using the magnetic material part with laminated steel plates.

FIG. 13 is a plan view showing an appearance of a stator before molding according to Embodiment 2.

FIG. 14A and FIG. 14B each are a perspective view of an insulator constituting a core piece of the stator according to Embodiment 2 when viewed from different angles.

FIG. 15 is a plan view showing an appearance of the insulator constituting the core piece of the stator according to Embodiment 2.

FIG. 16A and FIG. 16B are schematic plan views showing a state in which the core piece members are connected by the first stage snap-fit coupling and a state in which the core piece members are connected by the final snap-fit coupling when the stator according to Embodiment 2 is to be manufactured, respectively.

FIG. 17 is a flowchart showing a manufacturing method for the stator according to Embodiment 2.

### MODES FOR CARRYING OUT INVENTION

### Embodiment 1

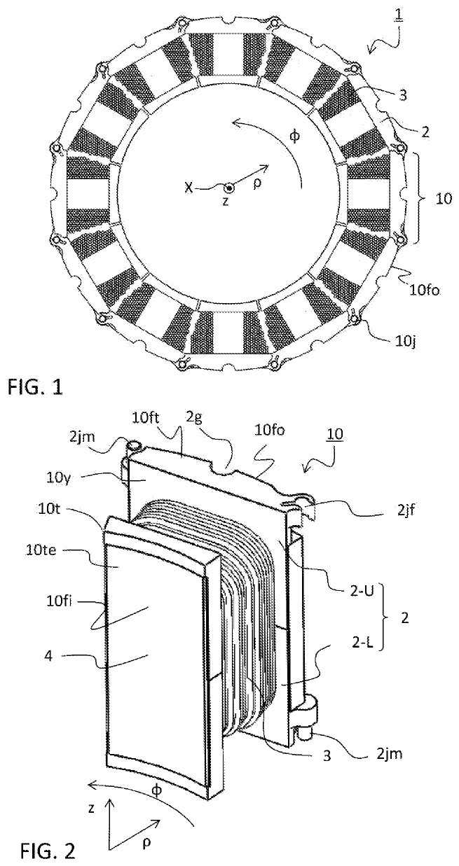

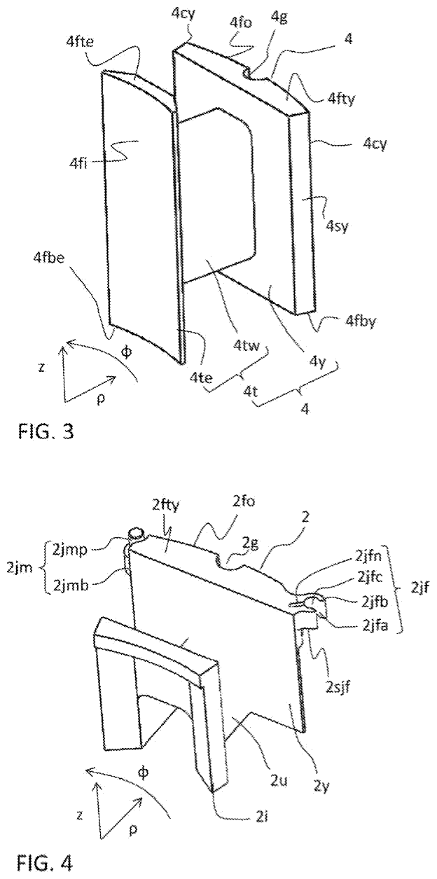

FIG. 1 to FIG. 12 illustrate a stator, a configuration of a rotating electrical machine using the stator, or a manufacturing method for the stator according to Embodiment 1. FIG. 1 is a plan view of an appearance of the stator before molding, showing the shape on a plane perpendicular to a rotation axis, FIG. 2 is a perspective view showing an appearance of a core piece constituting the stator as viewed from an inner peripheral side, FIG. 3 is a perspective view showing an appearance of a magnetic material part constituting the core piece as viewed from an inner peripheral side, the magnetic material part being formed by powder compaction molding, and FIG. 4 is a perspective view showing an appearance of an insulator constituting the core piece as viewed from an inner peripheral side among those exposed sides when the core piece is configured therewith.

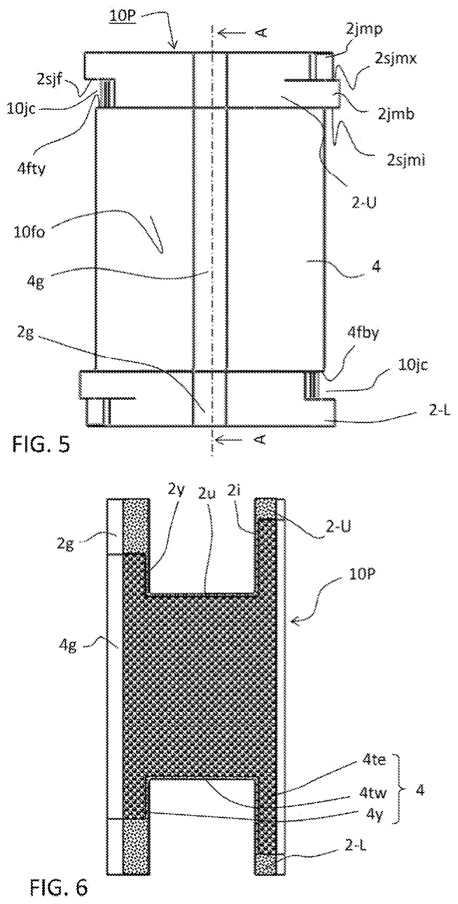

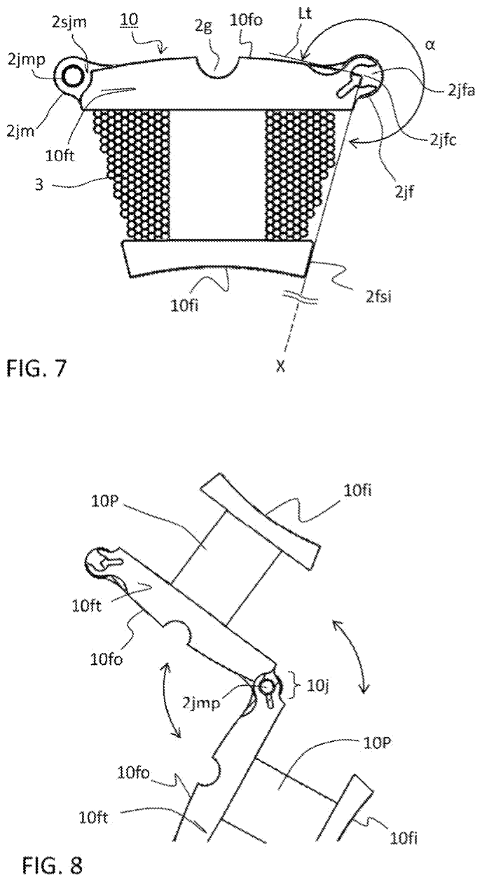

Further, FIG. 5 is a side view showing an appearance of a core piece member having the insulator mounted on the magnetic material part as viewed from an outer peripheral side. FIG. 6 is a cross-sectional view of the core piece member taken along the line A-A in FIG. 5 in a plane parallel to the axis direction and a radial direction, FIG. 7 is a plan view showing an appearance of the core piece member, and FIG. 8 is a plan view showing a state in which the core piece members are connected to each other by snap-fit coupling in a direction perpendicular to the axis.

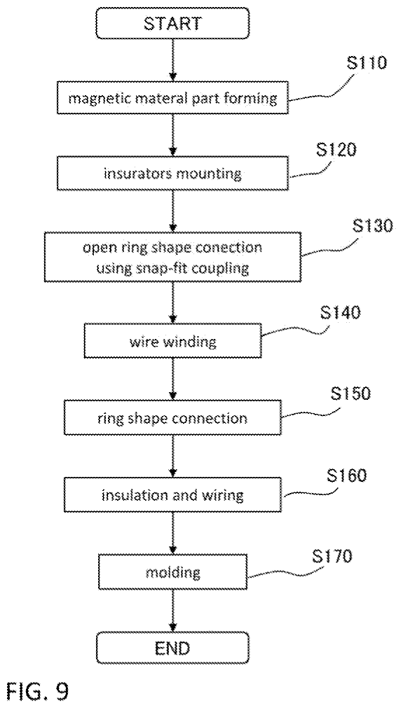

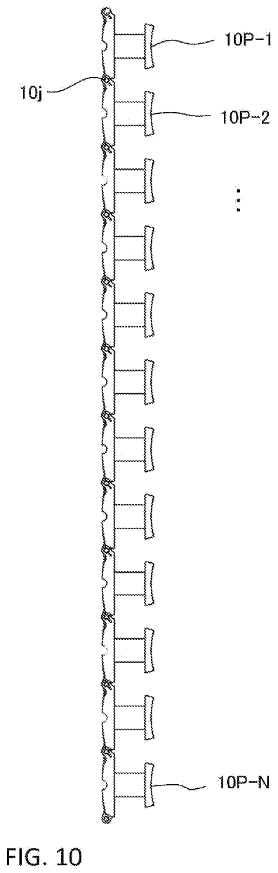

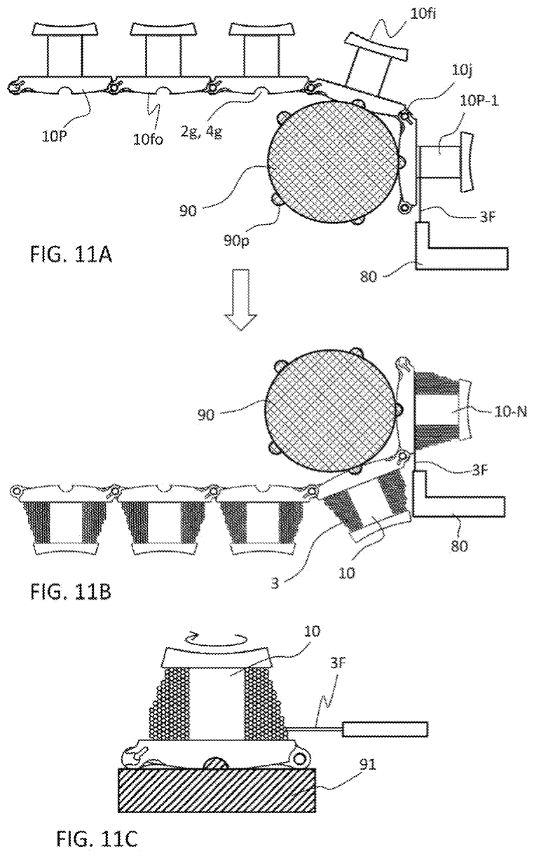

FIG. 9 is a flow chart showing a manufacturing method for the stator, FIG. 10 is a plan view showing a state in which the core piece members are connected by the snap-fit coupling in order for wire winding in a manufacturing process for the stator, and FIG. 11A to FIG. 11C include schematic plan views showing a state in which the core piece members are set in a wire winding machine (FIG. 11A) in order to wind the wire around each of the core piece members connected as shown in FIG. 10 in a manufacturing process for the stator and a state in which the wire winding is completed (FIG. 11B). Note that, in FIG. 1, FIG. 7, and FIG. 11A to FIG. 11C, drawings of winding portions of coils in the circumferential direction are omitted.

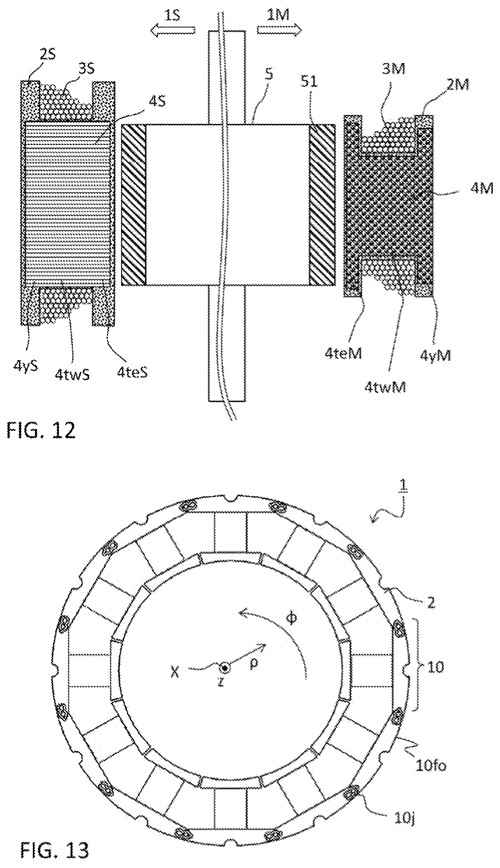

FIG. 12 is a schematic cross-sectional view in a plane including the axis in which it is assumed that the rotating electrical machine using the stator with the magnetic material part formed by the powder compaction molding is located in the right half and the rotating electrical machine using the stator with the magnetic material part formed with the laminated steel plates is located in the left half with the rotation axis as a border in order to compare the structure of the exemplified stator using the magnetic material part formed by the powder compaction molding with the stator using the magnetic material part formed with laminated steel plates.

The stator, the rotating electrical machine equipped with the stator, and a manufacturing method for the stator according to Embodiment 1 of the present application will be described below referring to the drawings. As shown in FIG. 1, the stator 1 has twelve core pieces 10 formed in a ring shape, which are connected through coupling parts 10j by the snap-fit coupling in which insertion is made in a direction perpendicular to the axis (rotation axis X). As shown in FIG. 2, the core piece 10 includes a yoke part 10y having an arc-shaped outer peripheral face 10fo, a tooth part 10t protruding toward the axis from the middle part of the yoke part 10y in the circumferential direction (φ direction), and a coil 3 wound around the tooth part 10t. An insulator 2 that is non-conductive is interposed between the magnetic material part 4 and the coil 3.

Members constituting the core piece 10 will be described. As a material for the wire 3F constituting the coil 3, a conducting wire in which a conductive material such as copper or aluminum is covered with an insulating material is used, and either a round wire having a circular cross section or a rectangular wire having a rectangular cross section may be used.

Magnetic Material Part

The magnetic material part 4 is formed, for example, by molding a material such as iron, Fe—Si, and amorphous metal which are soft magnetic materials. Needless to say, a resin material may be added as necessary. As shown in FIG. 3, the magnetic material part 4 is in a shape such that a yoke 4y having an arc-shaped outer peripheral face 4fo is integrated with a tooth 4t having a T-shaped cross section perpendicular to the axis.

The outer peripheral face 4fo of the yoke 4y has the arc shape, and a groove 4g extending in the axis direction from a bottom face 4fby to a top face 4fty is formed at the center of the outer peripheral face 4fo in the circumferential direction (φ direction). The groove 4g is continuous with a groove 2g of the insulator 2, which will be described later, and serves as a holding and positioning mechanism for the core piece 10 when the wire 3F is wound.

Further, an inner peripheral face 4fi of the tooth 4t in the magnetic material part 4 also is in an arc shape, which forms a perfect circle when the core pieces 10 are connected as shown in FIG. 1, and the inner peripheral face 4fi of the tooth 4t is formed so as to have a gap of a constant interval with respect to a rotor 5 (FIG. 12). The outer peripheral face 4fo described above is also formed so as to be a perfect circle as with the inner peripheral face 4fi. In this case, both the outer peripheral face 4fo and the inner peripheral face 4fi are designed to be positioned to share the same axis centered on the rotation axis X.

Further, the top face 4fty and the bottom face 4fby in the yoke 4y of the magnetic material part 4 are designed to protrude from a winding portion 4tw of the tooth 4t in the axis direction, and the top face 4fte and the bottom face 4fbe in a tooth tip portion 4te are also designed to protrude from the winding portion 4tw. As a result, the thickness of the insulator 2 at the yoke part 10y and the tooth tip portion 10te can be reduced and the height of the winding portion can be lowered, as described later in detail (FIG. 12), so that the size of the stator 1 and the amount of wire 3F to be used can be reduced.

Insulator

The insulator 2 is formed in a shape to cover one side in the axis direction (z-direction) in the region surrounding the winding portion 4tw of the magnetic material part 4, for example, by molding an insulating thermoplastic resin. Specifically, as shown in FIG. 4, the insulator 2 includes a U-shaped portion 2u to cover the winding portion 4tw, an inner face portion 2i connecting radially inward (ρ-direction) from the U-shaped portion 2u to cover the face of the tooth tip portion 4te on the side to the winding portion 4tw, and a yoke portion 2y connecting radially outward from the U-shaped portion 2u to cover the face of the yoke 4y on the side to the winding portion 4tw.

As a result, as shown in FIG. 5 and FIG. 6, by mounting two insulators 2-U and 2-L on the side of the top face 4fty and on the side of the bottom face 4fby in the magnetic material part 4, respectively, a core piece member 10P in which the winding portion 4tw and the region surrounding the winding portion 4tw in the magnetic material part 4 are covered with the insulating material is formed. Note that, in the present application, in order to explain the state before and after the coil is wound in the manufacturing process, the core piece 10P in the state before the coil 3 is wound is distinguished from the core piece 10 in the state after the coil 3 is wound, but both may be collectively referred to as the core piece. Further, although the top face 4fty and the bottom face 4fby are separately described for ease of explanation, the top face 4fty and the bottom face 4fby may be symmetrical with respect to a plane perpendicular to the axis, and it is not necessary to distinguish the insulator 2-U and the insulator 2-L as members.

Further, a groove 2g connected to the above-described groove 4g is formed at the center in the circumferential direction (φ direction) of an outer peripheral face 2fo that is in an arc-shape. Further, a base portion 2jfb, which protrudes in the circumferential direction and the radial direction and has a C-shaped cross-section perpendicular to the axis, is provided at one end (right in the figure) of a top face 2fty which is an end face of the yoke portion 2y in the axis direction on the side away from the U-shaped portion 2u. In the C-shaped base portion 2jfb, an open ring portion 2jfc which is formed to be in an open ring by an opening portion 2jfa opened in a direction perpendicular to the axis and functions as a snap-fit recess 2jf for extraction or insertion in a direction perpendicular to the axis.

Further, a snap-fit protrusion 2jm that has a base portion 2jmb protruding in the circumferential direction and the radial direction, and a pillar portion 2jmp extending in the axis direction from the base portion 2jmb is provided at the other end (left in the figure) of the top face 2fty. Note that the base portion 2jmb protrudes from a position (corresponding to the position of a lower face 2sjf of the base portion 2jfb) which is the position lowered from the top face 2fty toward a bottom face 2fby by an amount corresponding to the thickness of the base portion 2jfb of the snap-fit recess 2jf. Further, the outer diameter of the pillar portion 2jmp is designed to be larger than the inner diameter of the open ring portion 2jfc when the open ring portion 2jfc of the snap-fit recess 2jf is free. This is to prevent the pillar portion 2jmp from coming off from the open ring portion 2jfc when the pillar portion 2jmp is fitted into the open ring portion 2jfc to form the coupling part 10j, which will be described later.

The opening portion 2jfa of the snap-fit recess 2jf is designed such that the width of the opening portion 2jfa when the snap-fit recess 2jf is free is equal to or smaller than the diameter of the pillar portion 2jmp. This is also to prevent the pillar portion 2jmp from coming off easily after the coupling part 10j is formed by the snap-fit coupling. Accordingly, the pillar portion 2jmp is inserted from a direction perpendicular to the axis into the opening portion 2jfa of an adjacent core piece 10, which will be described later, thereby the coupling part 10j is formed by the firm snap-fit coupling, and the pillar portion 2jmp is rotatably held in the open ring portion 2jfc, as described later.

Note that the snap-fit recess 2jf may be provided with a notch 2jfn on the side opposite to the opening portion 2jfa, if necessary. By providing the notch 2jfn, effects are brought about in that force for expanding the opening portion 2jfa is reduced, the pillar portion 2jmp smoothly fits into the open ring portion 2jfc, and the base portion 2jfb is prevented from breaking when force is applied from the inner circumferential face side of the open ring portion 2jfc to the outer circumferential face side thereof.

Here, the direction of the opening of the opening portion 2jfa in the snap-fit recess 2jf (the direction of a straight line extending from the center of the open ring portion 2jfc toward the center of the opening portion 2jfa) is set within the range of the angle a shown in FIG. 7. Specifically, the range of the angle is a clockwise range defined by the start point that is a tangent line Lt to an circular arc formed by the outer peripheral face 2fo (the outer peripheral face 10fo in the figure), which is drawn from the center of the open ring portion 2jfc and extends to the circumferential inner direction, and the end point that is a line extending from the center of the open ring portion 2jfc toward the center (rotation axis X) of the circular arc. Note that, depending on the accuracy of the circular arc, a line along a side face 2fsi may be used as the end point instead of the center of the circular arc.

In addition, the position of the center of the pillar portion 2jmp is designed to coincide with that of an end 4cy (FIG. 3) in the direction perpendicular to the axis when the insulator 2 is mounted to the magnetic material part 4, the end 4cy being on the side of the outer peripheral face 4fo of the magnetic material part 4. Similarly, the position of the center of the open ring portion 2jfc is designed to coincide with that of the end 4cy on the other side when the insulator 2 is mounted to the magnetic material part 4.

Next, a description will be given on a freely rotatable structure centered on the coupling part 10j when the coupling part 10j is formed by connecting the core piece members 10P by the snap-fit coupling, the core piece member 10P being structured by mounting the insulator 2 on the side of the top face 4fty and on the side of the bottom face 4fby each in the magnetic material part 4.

A plurality of the core piece members 10P are arranged such that inner peripheral faces 10fi or outer peripheral faces 10fo face the same side to each other, and side end faces 4sy of yokes 4y face each other. As a result, the snap-fit protrusion 2jm becomes adjacent to the snap-fit recess 2jf both on the side of the top face 10ft and on the side of a bottom face (reference numeral is not shown) between the core piece members 10P adjacent to each other. Then, the orientation of the opening portion 2jfa with respect to the pillar portion 2jmp in the other side is also in the same relation on the side of the top face 10ft and on the side of the bottom face (same in top side and bottom side).

At this time, the angle between the core piece members 10P is adjusted such that the upper and lower opening portions 2jfa are positioned on a line connecting the center of the pillar portion 2jmp and the center of the open ring portion 2jfc that are adjacent to each other, and the pillar portion 2jmp is pushed toward the center of the open ring portion 2jfc. That is, by the insertion in the direction perpendicular to the axis, the coupling part 10j by the snap-fit coupling is simultaneously formed on the side of the top face and on the side of the bottom face. At this time, although mounting them manually is possible, they may be fitted using a jig or the like.

Here, the snap-fit recess 2jf and the snap-fit protrusion 2jm are fitted with each other at a gentler slope angle with respect to a plane perpendicular to the release direction which is opposite to the insertion direction, and the force in the direction to which the opening portion 2jfa is widened is generated by the pulling in the release direction. This makes it possible to detach the core piece members 10P that are connected; that is, the snap-fit coupling can be released.

However, in the typical snap-fit coupling, force is applied to a direction perpendicular to the release direction, and the snap-fit protrusion is moved from the snap-fit recess, so that the engagement is released. In contrast, in the case where the release is enabled by the pulling in the release direction, it is necessary to set a large pressing force at the time of fitting in order to prevent the coupling from being accidentally released after the coupling. Therefore, a strong force is required to fit them on the top and bottom face sides at the same time. For example, if the snap-fit coupling is formed first on the side of the top face 10ft, and then the snap-fit coupling on the bottom side is followed, the snap-fit coupling can be formed with less force. Alternatively, on the side of the top face 10ft, simply, the insertion may be performed in the axis direction instead of the snap-fit coupling, and then the snap-fit coupling on the bottom face side may be performed.

In this case, by bringing the pillar portion 2jmp closer to the opening portion 2jfa with its axis inclined with respect to the opening portion 2jfa on the side of the top face 10ft, it is possible to fit with less force compared with the case where the axis is not inclined. Further, in the case where the pillar portion 2jmp is fitted into the open ring portion 2jfc on the side of the bottom face, with the coupling part 10j on the side of the top face 10ft side as the supporting point, they can be fitted with ease without the angle between the core pieces 10P changing unsteadily.

Further, since the pillar portion 2jmp is fitted into the open ring portion 2jfc, which is a structure with a feature inherent in the present application, rotation (indicated by arrow) about the pillar portion 2jmp is freely possible each between the core piece members 10P as shown in FIG. 8. Meanwhile, the base portion 2jmb is fitted into a gap 10jc (FIG. 5) between the base portion 2jfb and the top face 4fty. Therefore, when the core piece member 10P is to move in the direction toward the top face 10ft, the movement is restricted by the contact between an outer face 2sjmx in the axis direction of the base portion 2jmb of the core piece member 10P and an lower face 2sjf of the base portion 2jfb of the adjacent core piece member 10P. Further, when the core piece member 10P is to move in the direction toward the bottom face (the rear side to the top face 10ft), the movement is restricted by the contact between an inner face 2sjmi in the axis direction of the base portion 2jmb of the core piece member 10P and the top face 4fty of the magnetic material part 4 of the core piece member 10P adjacent thereto.

That is, the movement of the core piece member 10P in the axis direction is restricted, so that the detachment of the core piece members 10P due to displacement in the axis direction can be prevented. Therefore, a state in which a plurality of the core piece members 10P or a plurality of the core pieces 10 are connected to each other (refer to FIG. 10 and FIG. 11) can be easily maintained, and thus the connection into the ring shape as shown in FIG. 1 can be also easily made.

Note that the inner peripheral face of the open ring portion 2jfc does not need to be an arc as long as the pillar portion 2jmp can be rotated. Further, the pillar portion 2jmp does not need to be a cylinder as long as a required rotation range can be secured, and for example, in the case where it is desired to hold the pillar portion 2jmp at a certain angle, the cross-sectional shape thereof may be suitably changed to an elliptic shape, a shape with a partial cutout, or the like.

Next, a manufacturing method for the stator 1 according to Embodiment 1 will be described referring to the flowchart of FIG. 9. First, the magnetic material part 4 is formed by the powder compaction molding using a powder core material as a soft magnetic material (step S110). Further, although not shown, the insulator 2 is formed by molding using an insulating resin such as a thermoplastic resin.

Then, the insulators 2 each are mounted on the top faces 4fte, 4fty and the bottom faces 4fbe, 4fby in the magnetic material part 4 to form a core piece member 10P. When a certain amount of the core piece members 10P is prepared, the core piece members 10P in the required number are aligned in the same direction, as described above, and the snap fit recess 2jf and the snap protrusion 2jm in the adjacent insulators 2 are connected by the snap-fit coupling. When, for example, N (=12) pieces of the core pieces 10 are required as the stator 1, N pieces of the core piece members 10P are formed as a connecting member not in the ring shape but in an open ring shape, in which the core piece members 10P (10P-1, 10P-N) are not connected at the end positions (step S130) as shown in FIG. 10.

Thereafter, in order to make the grooves 2g and 4g of the core piece member 10P on the side of the outer peripheral face 10fo in the connecting member function as a positioning mechanism, the connecting member in the open ring shape is set such that the outer peripheral face 10fo faces a rotating roller 90 of a winding machine as shown in FIG. 11A. That is, the rotating roller 90 is provided with protrusions 90p for positioning and fixing the core piece members 10P, and the position of the core piece member 10P is fixed by the protrusion 90p which comes in contact with the groove 4g and the groove 2g on the side of the outer peripheral face 10fo of the core piece member 10P. The connecting member of the core piece members 10P set in the wire winding machine is automatically rotationally conveyed (clockwise in the figure) by the rotating roller 90 such that core piece member 10P is positioned right before a flyer 80 of the wire winding machine one by one.

The connecting member set on the rotating roller 90 of the wire winding machine is bent at the coupling part 10j with the inner peripheral face 10fi directing outward such that the angle between the teeth 4t of the core piece members 10P adjacent to each other on the right and left sides is enlarged. Therefore, without interfering with the core piece members 10P on both sides of the core piece member 10P concerned, the wire 3F is densely wound on the core piece member 10P concerned via the flyer 80 to form the coil 3 (step S140). After the winding, in order to wind the next core piece member 10P, the rotating roller 90 of the winding machine rotates, and the core piece member 10P to be the target is automatically rotationally conveyed until it is right before the flyer 80. Then, the wire 3F is wound around the target core piece member 10P by the flyer 80 again to form the coil 3.

By repeating the rotational conveyance by the rotary roller 90 of the wire winding machine and the winding of the wire 3F by the flyer 80, the wire 3F is wound around for all the core piece members 10P, as shown in FIG. 11B, to form the core piece members 10 having the coil 3. Further, if necessary, the wire 3F may be cut between the core piece members 10.

Note that an example at this time is shown in which the core piece members 10P in the number (N=12) of pieces necessary for the structure of the stator 1 are connected and the wire 3F is wound to form the core piece members 10 for the necessary pieces of number at a time. However, this example is not a limitation. For example, after the wire 3F may be wound in a set of six core piece members 10P of a connecting member, the set of six being a division of the necessary number of pieces by two, and then the connecting members of the two sets of core piece members 10 may be connected to form the connecting member with twelve core pieces 10.

Alternatively, step S130 may be omitted, and after the core piece members 10 are wound independently, the core piece members 10 wound independently may be connected by a necessary number (12 pieces) later. That is, a plurality of sets of connecting members of one or more core piece members 10P may be formed, and after each connecting member is wound, the plurality of connecting members may be connected to each other. Note that, in the case where the core piece member 10 is wound independently, as shown in FIG. 11C, a spindle system may be used in which the core piece member 10 is attached to a rotary drive unit 91 instead of the flyer and the core piece member 10 itself is rotated to be wound.

As described above, when the number of core pieces 10 necessary for the structure of the stator 1 has been prepared, the core pieces 10 are rotated and connected to make the core pieces 10 in the ring shape such that the inner peripheral faces 10fi (teeth part side) of the core pieces 10 face the inner side (step S150). After performing an insulation process and a wiring process (step S160) which is to be required, the core pieces 10 in the ring shape are set in a die and molded with a resin (step S170), thereby completing the stator 1.

Further, using a housing (not shown) having bearings, the completed stator 1 is held on the inner wall of the housing, and the rotor 5 (FIG. 12) is combined to be rotatably supported on the side of the inner peripheral face of the stator 1 with the above-described bearings, thereby completing the rotating electrical machine.

As described above, in the stator 1 according to Embodiment 1, the snap-fit protrusion 2jm and the snap-fit recess 2jf for forming the coupling part 10j by the snap-fit coupling are provided adjacent to each other on the insulator 2 of each core piece 10. The snap-fit protrusion 2jm and the snap-fit recess 2jf are fitted with each other by the insertion of the pillar portion 2jmp into the open ring portion 2jfc in the direction perpendicular to the axis direction, thereby forming a coupling part 10j that is rotatable and restricts displacement in the axis direction.

Further, the rotation axis of the coupling part 10j is made to coincide with the end 4cy along the circular arc of the outer peripheral face 10fo as the core piece member 10P or the magnetic material part 4. Therefore, the coupling and the rotation mechanism are provided only in the insulator 2, each core piece 10 can be easily connected and rotated after the coupling, and it is not necessary to provide the magnetic material part 4 with a complicated shape for forming the coupling and the rotation mechanism. Further, the side end faces 4sy of the yokes 4y of the core pieces 10 adjacent to each other can be brought into close contact just by adjusting the rotation angle at the coupling part 10j such that the teeth 4t of the core pieces 10 are inside.

On the other hand, for example, in the structure disclosed in Patent Document 1 in which the laminated iron cores of adjacent core pieces are to be engaged with each other, the use of a plurality of types of laminated iron cores and punched caulking are necessary. Thus, problems arise in that a progressive die for producing the laminated core is complicated, and caulking equipment is also required, resulting in high introduction cost and increased number of parts. In contrast, according to the stator 1 of the present application, since the insulator 2 is provided with the mechanism that enables the coupling and rotation of the core piece 10, it is not necessary to use such complicated equipment for processing a steel plate, bringing about an effect in reducing the equipment cost. Further, in the coupling of the core pieces 10, since the work for the coupling can be performed without using any special equipment or a jig, the material handling can be improved.

In addition, as in the present application, since the coupling and rotation mechanism is formed in the insulator 2, which is a resin member, it is not necessary to form the coupling and rotation mechanism in the magnetic material part 4, so that the magnetic material part 4 can be formed by the powder compaction molding, although mechanical strength of the part thereby is inferior to that of the steel plate. In the powder compaction molding process, there is no need to use a complicated and expensive die such as the progressive die, and a single-shot die is used, thereby reducing the equipment cost. Further, in the case of using the laminated steel sheet, since the steel sheet is punched by a press machine, the number of unnecessary residual members increases and the yield decreases, but in the case of the powder compaction molding, since the molding can be performed only with the amount of powder to be required, the yield can be kept high.

Further, in the structure disclosed in, Patent Document 2, for example, in which the insulator is provided with a coupling and rotation mechanism, the number of types of members increases, and it is necessary to alternately arrange different types of members, and thus a problem arises in that the manufacturing process is complicated. Further, since the structure is such that the protrusion is inserted into the insertion hole in the axis direction, when the teeth are directed outward and the engagement between adjacent steel plates is lost, the position in the axis direction between core pieces is not fixed, and the core pieces fall out in some cases, and thus a problem of the difficulty in manufacturing arises.

In contrast, according to the stator 1 of the present invention, the snap-fit structures for the extraction or the insertion in the direction perpendicular to the axis direction can be formed in an alternating way, and the core pieces 10P of the same type can be connected to each other by the insertion in the direction perpendicular to the axis direction. Further, because of the extraction or the insertion in the direction perpendicular to the axis direction, an engaging structure for restricting the movement in the axis direction can be easily formed at the same time when the coupling is made, so that there is no positional shift in the axis direction between the core pieces 10P after the coupling, and workability is also good.

Note that the magnetic material part 4 of the core piece 10 constituting the stator 1 in the present application can be formed with laminated steel plates instead of using the powder compaction molding. Here, in particular, the advantages of the formation by the powder compaction molding will be described referring to FIG. 12. It is assumed that stators 1S and 1M are respectively constructed by using a magnetic material part 4S formed with the laminated steel plates and a magnetic material part 4M formed by the powder compaction molding, and then FIG. 12 is a schematic cross-sectional view of the rotating electrical machine showing the stators switched at the border of the rotation axis, the rotating electrical machine being structured such that the stators 1S and 1M each of which can receive the same amount of magnetic flux are assumed to be formed when the rotor 5 having magnets 51 on the side of the outer peripheral face thereof is arranged so as to be rotatable to share the same axis of the stator 1. Here, “S” and “M” are indicated at the ends of the reference numerals to distinguish the case where the magnetic material part is formed with the laminated steel plates (left side in the figure) from the case where the magnetic material part is formed by the powder compaction molding (right side in the figure), respectively.

When the magnetic material part 4S is formed using the laminated steel plates, it is difficult to form the yoke 4yS and the tooth tip portion 4teS so as to be different from the winding portion 4twS in height. Therefore, by making the thickness of the insulator 2S covering the yoke 4yS and the tooth tip portion 4teS larger than the thickness of the insulator 2S covering the winding portion 4twS, a structure with a wall for preventing winding collapse of the coil 3S is adopted. Accordingly, the amount of resin to be required for forming the insulator 2S is likely to be increased.

In contrast, in the case where the magnetic material part 4M is formed by the powder compaction molding, the magnetic material part 4M is formed by compressing a powder such as iron powder, so that the magnetic material part 4M has a high degree of freedom in structure. Therefore, with the magnetic material part 4M itself, the height of the yoke 4yM and the tooth tip portion 4teM can be made larger than the height of the winding portion 4twM, so that a structure for preventing the winding collapse of the coil 3M can be formed. Therefore, as long as the insulator 2M has a thickness that does not impair the insulating function, it is possible to reduce the covering thickness as compared with the case where the magnetic material part 4S made of the laminated steel plates is used, and it is possible to reduce the amount of resin required for forming the insulator 2M.

Further, in the magnetic material part 4M formed by the powder compaction molding, the tooth tip portion 4teM can be extended up to a region where the coil 3M is formed in the axis direction. As a result, since the density of the magnetic flux interlinked with the winding portion 4twM can be increased by receiving the magnetic flux in the region, there is no problem even if the height of the winding portion 4twM is made lower as compared with the magnetic material part 4S made with the laminated steel plates. When the height of the winding portion 4twM can be lowered, the height of the wire 3F at the winding portion can be made lower, so that the amount of the wire 3F to be used can be reduced and the stator 1 can be miniaturized, as compared with the stator 1S.

Needless to say, in the stator 1 of the present application, the magnetic material part 4M made by the powder compaction molding is not essential for the magnetic material part 4. However, since the rotatably connected structure of the core pieces 10 to each other (core piece member 10P) can be formed by the insulator 2, the magnetic material part 4 formed by the powder compaction molding can be used, and the amount of resin to be used for the insulator 2 can be reduced and the yield of the magnetic material part can be improved. Further, it is possible to reduce the amount of the wire 3F to be used, and to miniaturize the stator 1.

Further, as the advantage when the magnetic material part 4 is formed by the powder compaction molding, a structure in which the height in the axis direction in the yoke side and the tooth tip portion is larger than that of the winding portion in the tooth has been described, but this is not a limitation. The height of the yoke side or the tooth tip portion may be the same as the height of the winding portion in the tooth, just as the case where the magnetic material part 4 may be formed with the laminated steel plates.

In the formation of the coil 3 on the core piece member 10P, only one flyer 80 is used for the winding, but in order to reduce the cycle time, a plurality of flyers 80 may be used to wind a plurality of the core piece members 10P at the same time. Further, as will be exemplified in Embodiment 2, the pillar portion 2jmp of the snap-fit protrusion 2jm in the coupling part 10j may have a portion at the tip end thereof (enlarged portion 2jmpw described later) which is sufficiently larger than the inner radius of the open ring portion 2jfc of the snap-fit recess 2jf. In this case, even when the gap 10jc between the base portion 2jfb and the top face 4fty is not provided, the portion having a larger diameter serves as a hook, and it is possible to prevent the positional shift toward the axis direction between the adjacent core piece members 10P.

### Embodiment 2

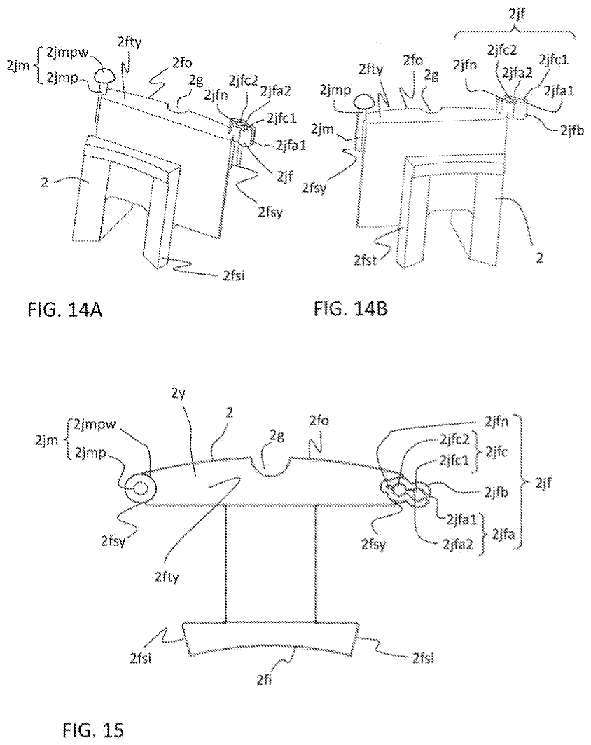

In Embodiment 1 described above, an example has been described in which the coupling part protrudes from the circular arc formed by the outer peripheral face of the yoke. In Embodiment 2, an example will be described in which a coupling part is placed inside a circular arc formed by the outer peripheral face of the yoke. FIG. 13 to FIG. 17 illustrate diagrams for explaining a stator or a manufacturing method for the stator, according to Embodiment 2, and FIG. 13 is a plan view showing the appearance of the stator corresponding to FIG. 1 in Embodiment 1 before molding, FIG. 14A and FIG. 14B are perspective views at different angles from the inner peripheral face side among those exposed sides when an insulator is placed to cover a magnetic material part, and FIG. 15 is a plan view of an exposed side when the insulator is placed to cover on the magnetic material part.

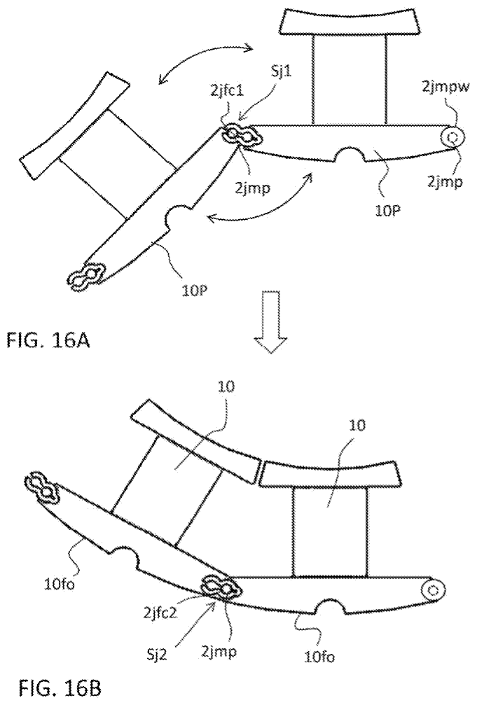

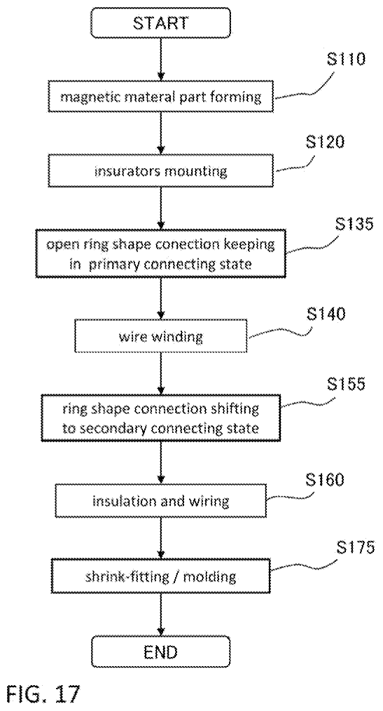

Further, FIG. 16A and FIG. 16B include schematic plan views showing states in which two core piece members are connected by the first stage snap-fit coupling (FIG. 16A) and in which two core piece member are connected by the final snap-fit coupling (FIG. 16B), respectively, and FIG. 17 is a flowchart showing a manufacturing method for the stator. Note that the same components as those of Embodiment 1 will be described referring to the drawings and the description used in Embodiment 1, the same components will be denoted by the same reference numerals as those of Embodiment 1, and parts different from Embodiment 1 will be mainly described. Note that, in FIG. 13, FIG. 16A, and FIG. 16B, a part of the drawing (the coil 3 and the enlarged portion 2jmpw) is omitted for ease of explanation.

In Embodiment 1, as described referring to FIG. 1, an example has been described in which the coupling part 10j formed by the snap-fit coupling between the core pieces 10 connected in the ring shape protrudes outward from the circular arc formed by the outer peripheral face 10fo (the same as the outer peripheral face 4fo of the magnetic material part 4). That is, when the core pieces 10 are connected in the ring shape, since the coupling part 10j made of a resin material of the insulator 2 protrudes from the outer peripheral face 10fo at the outermost periphery thereof, the core pieces 10 cannot be shrink-fitted in order to fix the core pieces 10 in the ring shape. Further, when molding is performed, since the outer peripheral face 10fo of the connecting member in the ring shape is separated from the die due to the coupling part 10j, the core pieces are easily rotated, resulting in insufficient fixation and making the molding difficult.

In contrast, in the stator 1 of Embodiment 2, in order to solve the problems that the shrink-fitting cannot performed and the core pieces are insufficiently fixed, the coupling part 10j has a structure that does not protrude from the outer peripheral face 10fo as shown in FIG. 13 when the core pieces 10 are formed in the ring shape. Further, as shown in FIG. 14A, FIG. 14B and FIG. 15, the snap-fit recess 2jf has a two stage structure in which a first open ring portion 2jfc1 and a second open ring portion 2jfc2 are provided and the shape thereof perpendicular to the axis is a gourd shape, so that the structure is configured to be able to shift from a rotatably connected state to a connected and fixed state in which rotation is not possible.

Specifically, as in Embodiment 1, insulator 2 is configured to cover from the upper face 4fty side and the bottom face 4fby side (FIG. 3) of the magnetic material part 4 respectively, but the structure for forming the coupling part 10j is different. In the snap-fit protrusion 2jm, the pillar portion 2jmp protrudes toward the axis direction from the top face 2fty of the yoke part 2y and does not protrude outward in the radial direction from the outer peripheral face 2fo. The center of the pillar portion 2jmp is located on a side face 2fsy (side end face 4sy), and the semicircular portion of the pillar portion protrudes from the side face 2fsy.

Meanwhile, as for the snap-fit recess 2jf, the base portion 2jfb is located above the top face 2fty of the yoke part 2y in the axis direction but does not extend outward in the radial direction from the outer peripheral face 2fo. And the first open ring portion 2jfc1 is located outside the side face 2fsy of the yoke part 2y in the circumferential direction. On the other hand, the center of the second open ring portion 2jfc2 which is continuous to the inner side of the first open ring portion 2jfc1 via a second opening portion 2jfa2 is located on the position of the side face 2fsy (side end face 4sy), and a groove whose cross-sectional shape perpendicular to the axis direction is semicircular is formed in the region below the top face 2fty.

Note that, also in Embodiment 2, the inner diameters of the first open ring portion 2jfc1 and the second open ring portion 2jfc2 (collectively, the open ring portion 2jfc) in a free state are designed to be equal to or smaller than the diameter of the pillar portion 2jmp. This is to prevent the snap fit protrusion 2jm (pillar portion 2jmp) fitted in the snap fit recess 2jf from coming off easily. Further, the opening widths in the first opening portion 2jfa1 and the second opening portion 2jfa2 in the free state are also designed to be equal to or smaller than the diameter of the pillar portion 2jmp. This is also to prevent the snap-fit protrusion 2jm fitted to the snap-fit recess 2jf from coming off easily.

Further, in Embodiment 2, at the tip of the pillar portion 2jmp, the enlarged portion 2jmpw having a larger radius than that of the pillar portion is formed. The enlarged portion 2jmpw is to be located on the upper face side of the base portion 2jfb of the snap fit recess 2jf and is formed at a position to protrude above the base portion 2jfb when the snap fit protrusion 2jm is inserted into the snap fit recess 2jf. And the diameter of the pillar portion is set to be larger than a diameter of the first open ring portion 2jfc1 or the second open ring portion 2jfc2 that is widened at the time when the pillar portion passes through the first opening portion 2jfa1 or the second opening portion 2jfa2.

In the same manner as in Embodiment 1, the core piece member 10P is formed by covering the upper and lower portions of the magnetic material part 4 with the insulator 2. Also in Embodiment 2, when the teeth are arranged to be directed in the same direction, the core piece members 10P thus constructed are also configured to be arranged such that the snap fit protrusion 2jm of one core piece member 10P is adjacent to the snap fit recess 2jf of the other core piece member 10P. However, both the snap-fit recess 2jf and the snap-fit protrusion 2jm do not protrude from the outer peripheral face 10fo but protrude in the circumferential direction and protrude outward in the axis direction with respect to each top face 2fty.

With such a structure, the pillar portion 2jmp of the snap-fit protrusion 2jm is fitted into the adjacent snap-fit recess 2jf by the insertion thereof in the direction perpendicular to the axis direction. As a first step, as shown in FIG. 16A, the pillar portion 2jmp passes through the first opening portion 2jfa1 and fits into the first open ring portion 2jfc1 and is stably held in the first open ring portion 2jfc1, and the two core piece members 10P are connected by the snap-fit coupling.

This connection is defined to be in a primary connecting state Sj1, and since the outer circumference of the pillar portion 2jmp and the inner circumference of the first open ring portion 2jfc1 are both circular, the pillar portion 2jmp is held rotatable about the center of the first open ring portion 2jfc1 at the coupling part 10j in the primary connecting state Sj1. Further, as described above, since the center of the first open ring portion 2jfc1 is located at a position circumferentially apart from the side face 2fsy, the side faces 2fsy on the yoke side of the core piece members 10P that are adjacent are separated from each other in the primary connecting state. That is, in the primary connecting state Sj1 shown in FIG. 16A, the adjacent core pieces 10P are not in contact with each other in the direction perpendicular to the axis except for the pillar portion 2jmp and the first open ring portion 2jfc1 on the same axis.

As a result, when the teeth are moved to direct outward, the teeth can be rotated until the outer peripheral faces 10fo of the adjacent core piece members 10P contact with each other. To the contrary, when the teeth are moved to direct inward, the core piece members 10P can be rotated until the side faces 2fsi of the teeth (FIGS. 14 and 15) of the adjacent core piece members 10P contact each other.

From the primary connecting state Sj1, when the teeth are rotated to direct inward and the pillar portion 2jmp is fitted into the second open ring portion 2jfc2 through the second opening portion 2jfa2 as shown in FIG. 16B, the pillar portion 2jmp is stably held in the second open ring portion 2jfc2. At this time again, the two core piece members 10 are connected by the snap-fit coupling. Note that, in this case, since the coil 3 is already wound as described later, the core piece is denoted as the core piece 10 with the reference numeral 10, although the coil 3 is omitted in FIG. 16B.

This connection is defined to be in a secondary connection state Sj2, and since the outer circumference of the pillar portion 2jmp and the inner circumference of the second open ring portion 2jfc2 are both circular, the pillar portion 2jmp should be held rotatable about the center of the second open ring portion 2jfc2 at the coupling part 10j in the secondary connecting state Sj2. However, as described above, since the center of the second open ring portion 2jfc2 is located on the position of the side face 2fsy, in the secondary connecting state Sj2, the side faces 2fsy (side end faces 4sy) on the yoke side of the adjacent core piece members 10P contact each other, and the side faces 2fsi on the teeth side also come close to each other.

That is, in the secondary connecting state Sj2 shown in FIG. 16B, the adjacent core piece members 10P are fixed in position and become non-rotatable by the pillar portion 2jmp fitting into the second open ring portion 2jfc2 on the side of the outer peripheral face 2fo and by the side faces 2fsy coming in contact with each other. Therefore, when the coupling part 10j is in the primary connecting state Sj1, a certain range is allowed as an angle between the adjacent core piece members 10P. However, at the time of shifting to the secondary connecting state Sj2, only an angle range for a state in which the side faces 2fsi come close to each other is allowed.

In FIG. 16A and FIG. 16B, as for the snap fit protrusion 2jm located between the adjacent core piece members 10P or the adjacent core pieces 10, the enlarged portion 2jmpw is omitted to indicate the position of the pillar portion 2jmp with respect to the first open ring portion 2jfc1 and the second open ring portion 2jfc2. However, in each of the connecting states shown individually in FIG. 16A and FIG. 16B, the enlarged portion 2jmpw above the first open ring portion 2jfc1 faces the upper face of the base portion 2jfb in the axis direction, thereby restricting the displacement (positional shift) in the axis direction between the adjacent core pieces 10 or the adjacent core piece members 10P.

Further, instead of providing the enlarged portion 2jmpw described above, a “stopper” may be provided not to allow the semicircular groove in the side face 2fsy on the side of the snap fit recess 2jf to penetrate into the lower face side, for example. Also in this case, the semicircular protrusion protruding from the side face 2fsy of the snap-fit protrusion 2jm can prevent the core piece member 10P from being shifted in the axis direction.

Alternatively, although it is necessary to provide two types of insulators, a first insulator provided with snap fit recesses 2jf at both ends and a second insulator provided with snap fit protrusions 2jm at both ends are formed. A core piece member using only the first insulator and a core piece member using only the second insulator are formed and arranged alternately. In this case, it is possible to prevent the positional shift in the axis direction at the same time as the snap-fit coupling without providing the enlarged portion 2jmpw or the “stopper”.

As described above, even in the structure in which the pillar portion is held in the open ring portion, it is possible to implement a mechanism for preventing the positional shift in the axis direction after the coupling by adopting a structure in which the formation of the coupling by the snap-fitting or the release of the coupling can be switched by the extraction or the insertion in the direction perpendicular to the axis. In contrast, for example, in the structure disclosed in Patent Document 2 for switching between the formation of the coupling and the release of the coupling by the extraction or the insertion in the axis direction, the shift in the axis direction cannot be prevented only by the coupling, and a jig or the like for keeping the coupling is required.

Next, a manufacturing method for the stator 1 according to Embodiment 2 will be described referring to the flowchart of FIG. 17, which focuses on the differences from Embodiment 1. In Embodiment 2, as in Embodiment 1, the insulators 2 are mounted to the magnetic material part 4 to form the core piece member 10P (steps S110 to S120). And by fitting together the snap-fit protrusion 2jm and the snap-fit recess 2jf that are adjacent to each other when the core pieces 10P are arranged to direct in the same direction, the coupling part 10j is formed by the snap-fit coupling.

However, the coupling part 10j at this stage is kept in the primary connecting state Sj1 in which the pillar portion 2jmp is held in the first open ring portion 2jfc1, and the connecting member is formed in an open ring shape (step S135). At this time of the stage, as described above, it is possible to divide the connecting member, and the core piece members 10P can be rotated about the first open ring portions 2jfc in the connected state.

Then, as described referring to FIG. 11 of Embodiment 1, the connecting member is set in the winding machine such that the outer peripheral face 10fo of each core piece member 10P faces the rotating roller 90, and the winding process of the wire 3F is performed for each core piece member 10P to form the core piece 10 having the coil 3 (step S140).

As described above, when a required number of core pieces 10 for the stator 1 are prepared, the core pieces 10 are rotated such that the side of the inner peripheral face 10fi of the core piece 10 is directed inward, and the core pieces 10 at the ends are connected to each other to be formed in the ring shape. Then, each pillar portion 2jmp is moved from the first open ring portion 2jfc1 to the second open ring portion 2jfc2, thereby shifting to the secondary connecting state Sj2 (step S155). Then, the side faces 2fsy (side end faces 4sy) of the core pieces 10 adjacent each other come into contact with each other, the side faces 2fsi come close to each other at a constant interval, and the core pieces 10 are in a fixed state in which the rotation about the coupling part 10j is not possible.

Thereafter, after performing an insulation process and a wiring process (step S160) as required, the core pieces 10 are completely fixed by the shrink-fitting, thereby completing the stator 1. In Embodiment 2, unlike Embodiment 1, since the snap-fit structure does not protrude from the outer peripheral face 10fo of the core piece 10, the rotation in the circumferential direction can be suppressed without using a jig or the like for the positioning, so that the shrink-fitting can be easily performed. Further, in Embodiment 2, when the secondary connecting state Sj2 is settled, the angle between the core pieces 10 does not change and is fixed, so that an appropriate ring shape can be maintained.

Therefore, without clinging to the shrink-fitting, even by the molding, it can be molded with high accuracy. Therefore, in step S175, at least one of the shrink-fitting and the molding may be performed.

Note that, although exemplary embodiments are described in the present application, various features, aspects, and functions described in one or more embodiments are not inherent in a particular embodiment and can be applicable alone or in their various combinations to each embodiment. Accordingly, countless variations that are not illustrated are envisaged within the scope of the art disclosed herein. The case where at least one component, for example, the number of poles or the groove 4g, etc., is modified, added or omitted are included.

In particular, regarding the rotating electrical machine, since the structure of the rotor 5 is not a characteristic part, the arrangement or usage of the magnet 51 is not limited to that shown in FIG. 12, and any arrangement or usage may be considered. Note that it is desirable that the specifications are those that meet an improved performance for the stator 1 described above. That is, it may be sufficient to have a structure in which the coupling part 10j is rotatable about the pillar portion 2jmp and fixes the positional relation with respect to the axis direction, by the snap-fit coupling formed with the pillar portion 2jmp extending in parallel with the rotation axis X and the open ring portion 2jfc, the snap-fit coupling being connected with respect to the direction perpendicular to the rotation axis X.

Further, for example, it is possible to provide a coupling part formed by the snap-fit coupling, in which a claw portion is provided at the tip of the pillar portion 2jmp, the claw portion being larger than the diameter of the open ring portion 2jfc and smaller than the diameter of the open ring portion 2jfc when the open ring portion 2jfc is expanded. In this case, although the snap-fit coupling is formed by the extraction or insertion in the axis direction, since the claw portion can prevent the pillar portion 2jmp from coming off in the axis direction from the open ring portion 2jfc, a coupling which enables the rotation and prevents the axial shift between adjacent core piece members 10P can be possible.

As described above, according to the stator 1 of each embodiment, a plurality of the core pieces 10 each of which includes the magnetic material part 4 in which the yoke 4y extending in an arc shape and the tooth 4t protruding from the yoke 4y toward the axis (rotation axis X) are formed, and a coil 3 wound around the tooth 4t, the core pieces 10 being arranged in a ring shape around the axis (rotation axis X), and the coupling part 10j having a fitting structure (for example, the gap 10jc with respect to the base portion 2jmb or the base portion 2jfb with respect to the enlarged portion 2jmpw and the top face 2fty) is formed between the core pieces 10 adjacent to each other in the arrangement of the ring shape, the coupling part 10j allowing the rotation about the pillar portion 2jmp and restricting the displacement in the axis direction by the snap-fit coupling (by the fitting) that is formed with the pillar portion 2jmp being provided on the yoke side of one of the core pieces (the yoke part 10y or near the end of the yoke part 2y in the circumferential direction) and extending in a direction parallel to the axis and the open ring portion 2jfc being provided on the yoke side of other of the core pieces (the same as above). Accordingly, the coil 3 having a high winding density can be formed without using the number of parts and a jig for fixing. Therefore, it is possible to obtain the stator 1 and the rotating electrical machine with high performance without increasing the number of parts and manufacturing processes.

The open ring portion 2jfc is provided with the gap 10jc between itself and the magnetic material part 4 in the axis direction, the pillar portion 2jmp is provided so as to extend from the base portion 2jmb having a larger diameter than the pillar portion 2jmp, and the base portion 2jmb of the one of the core pieces is configured to be inserted into the gap 10jc of the other of the core pieces when the snap-fit coupling described above is formed, so that the movement in the axis direction can be reliably restrained.

If the direction in which the pillar portion 2jmp is fitted into the open ring portion 2jfc is perpendicular to the extending direction of the pillar portion 2jmp, the displacement in the axis direction can be firmly restrained regardless of the force required for the insertion at the snap-fitting or the extraction. Further, the fitting structure (for example, the gap 10jc with respect to the base portion 2jmb or the base portion 2jfb with respect to the enlarged portion 2jmpw and the top face 2fty) for restricting the displacement in the axis direction can be easily formed without requiring any deformation, etc. of a member only for the formation of the structure.

Since the pillar portion 2jmp and the open ring portion 2jfc are provided as an integrally molded product of the insulator 2 made of resin, the insulator 2 being interposed between the magnetic material part 4 and the coil 3, the snap-fit structure in which both deformability and mechanical strength are required can be easily implemented.

If a compression-molded product using a powder is used as the magnetic material part 4, an optimum shape for a magnetic material can be easily produced.

Since the center of the open ring portion 2jfc is located at the end 4cy in the circumferential direction on the outer peripheral face 4fo of the yoke 4y, each core piece 10 is easily connected and can be rotated after the coupling. Further, the side end faces 4sy of the yokes 4y of the adjacent core pieces 10 can be brought into close contact with each other just by adjusting the rotation angle at the coupling part 10j such that the teeth 4t of the core pieces 10 are directed inward.

In contrast, if the open ring 2jfc portion and the pillar portion 2jmp are configured to be formed inward in a radial direction from an outer peripheral face 4fo of the yoke 4y, there is no portion protruding from the outer peripheral face 4fo of the yoke 4y when the core pieces are coupled in the ring shape, so that shrink-fitting can be possible. Also, when molding is performed, rotation with respect to the die is prevented, and thus the molding can be possible appropriately.

In this case, the open ring portion 2jfc is configured with the first open ring portion 2jfc1 whose center is located outside the end face (side end face 4sy) of the yoke 4y in the circumferential direction and the second open ring portion 2jfc2 which is connected to the first open ring portion 2jfc1 and whose center overlaps the end face (side end face 4sy), and the center of the pillar portion 2jmp (of the adjacent core piece 10 or core piece member 10P) is configured to overlap the end face (side end face 4sy) of the yoke 4y, and thus, when the coil 3 is wound, the pillar portion is fitted into the first open ring portion 2jfc1 to be rotated freely, and when the ring shape is formed, the pillar portion is fitted into the second open ring portion 2jfc2 and the ring shape is fixed, and the side end faces 4sy of the yokes 4y of the adjacent core pieces 10 can be brought into close contact with each other.

Further, according to the rotating electrical machine of each embodiment, since the rotating electrical machine is configured with the above-described stator 1, the rotor 5 coaxially disposed on the side of the inner peripheral face of the stator 1, and the housing holding the stator 1 and including a bearing (not shown) to support the rotor 5 rotatably, it is possible to obtain a rotating electrical machine with high performance at low cost or a small-sized rotating electrical machine at low cost.

As described above, according to the manufacturing method for the stator 1 of each embodiment, the method includes a step (steps S110 to S120) of forming the core piece member 10P by covering the magnetic material part 4 with insulators 2, the magnetic material part 4 being formed such that the yoke 4y extends in an arc shape and the tooth 4t protrudes from the yoke 4y toward an axis (rotation axis X), a step (step S130 or step S135) of forming the coupling part 10j having the fitting structure between the core piece members 10P adjacent to each other in arranging a plurality of the core piece members 10P such that the teeth 4t are directed to the same side and the end faces (side end faces 4sy) of the yokes 4y in the circumferential direction are arranged to face each other, the coupling part allowing rotation about the pillar portion 2jmp and restricting the displacement in the axis direction by the snap-fit coupling in which the pillar portion 2jmp being provided in the yoke part (the yoke part 10y or near the end of the yoke part 2y in the circumferential direction) of one of the core piece members and extending in the direction parallel to the axis (rotation axis X) is fitted into the open ring portion 2jfc being provided in the yoke part (the same as above) of other of the core piece members, a step (step S140) of forming the coil 3 by winding the wire 3F around each tooth 4t in each of a plurality of the core piece members 10P connected by the coupling part 10j with the angle between the teeth 4t of the core piece members 10P adjacent to each other widened, a step (step S150 or step S155) of connecting the core piece members 10P having the coils 3 formed thereon in the ring shape with the teeth 4t directed inward. Accordingly, the coil 3 having a high winding density can be formed without using the number of parts and a jig for fixing. Therefore, it is possible to obtain the stator 1 and the rotating electrical machine with high performance without increasing the number of parts and manufacturing processes.

As described above, according to another manufacturing method for the stator 1 according to each embodiment, the method also includes a step (steps S110 to S120) of forming the core piece member 10P by covering the magnetic material part 4 with insulators 2, the magnetic material part 4 being formed such that the yoke 4y extends in an arc shape and the tooth 4t protrudes from the yoke 4y toward an axis (rotation axis X), a step (step S140) of forming the coil 3 by winding the wire around each tooth 4t in each of a plurality of the core piece members 10P, and a step (step S130/step S135 and step S150/step S155) of connecting the core piece members in the ring shape with the teeth 4t directed inward after forming the coupling part 10j having the fitting structure between the core piece members 10P adjacent to each other in arranging a plurality of the core pieces member 10P having the coils 3 formed thereon such that the teeth 4t are directed to the same side and the end faces (side end faces 4sy) of the yokes 4y in the circumferential direction are arranged to face each other, the coupling part allowing the rotation about the pillar portion 2jmp and restricting the displacement in the axis direction between the adjacent core pieces member by the snap-fit coupling in which the pillar portion 2jmp being provided in the yoke 4y of one of the core piece members and extending in the direction parallel to the axis is fitted into the open ring portion being provided in the yoke 4y of other of the core piece members. Accordingly, the coil 3 having a high winding density can be formed without using the number of parts and a jig for fixing. Therefore, it is possible to obtain the stator 1 and the rotating electrical machine with high performance without increasing the number of parts and manufacturing processes.

Further, when the steps of forming the stator 1 by the above-described manufacturing method for the stator (step S110 to step S170) and a step of coaxially disposing the rotor 5 rotatably on the side of the inner peripheral face of the formed stator 1 are included, it is possible to obtain a rotating electrical machine with high performance at low cost or a small-sized rotating electrical machine at low cost, as described above.

### DESCRIPTION OF REFERENCE NUMERALS AND SIGNS

1: stator, 2: insulator, 2jf: snap-fit recess, 2jfb: base portion, 2jfc: open ring portion, 2jfc1: first open ring portion, 2jfc2: second open ring portion, 2jm: snap-fit protrusion, 2jmb: base portion, 2jmp: pillar portion, 3: coil, 4: magnetic material part, 4cy: end portion, 4fo: outer peripheral face, 4sy: side end face (end face), 4t: tooth, 4y: yoke, 5: rotor, 10: core piece, 10fo: outer peripheral face, 10jc: gap, 10P: core piece member, 10t: tooth part, 10y: yoke part, X: rotation axis (axis)

1-12. (canceled)

13. A stator comprising:
a plurality of core pieces each of which includes a magnetic material part in which a yoke extending in an arc shape and a tooth protruding from the yoke toward a rotation axis are formed, and a coil wound around the tooth, the plurality of core pieces being arranged in a ring shape around the axis, wherein
a coupling part having a fitting structure is formed between the core pieces adjacent to each other in an arrangement of the ring shape, the fitting structure allowing rotation about a pillar portion and restricting displacement in the axis direction by a snap-fit coupling that is formed with the pillar portion being provided on the yoke side of one of the core pieces and extending in a direction parallel to the axis and an open ring portion being provided on the yoke side of other of the core pieces,
the open ring portion is provided with a gap between the open ring portion and the magnetic material part in the axis direction,
the pillar portion is provided so as to extend from a base portion having a larger diameter than the pillar portion, and
the base portion of the one of the core pieces is inserted into the gap of the other of the core pieces when the snap-fit coupling is formed.

14. The stator according to claim 13, wherein a direction in which the pillar portion is fitted into the open ring portion is perpendicular to an extending direction of the pillar portion.

15. The stator according to claim 13, wherein the pillar portion and the open ring portion are provided as an integrally molded product of an insulator made of resin, the insulator being interposed between the magnetic material part and the coil.

16. The stator according to claim 13, wherein the magnetic material part is a compression-molded product using powder.

17. The stator according to claim 13, wherein a center of the open ring portion is located at an end of an outer peripheral face of the yoke in a circumferential direction.

18. The stator according to claim 13, wherein the open ring portion and the pillar portion are formed inward in a radial direction from an outer peripheral face of the yoke.

19. The stator according to claim 18, wherein
the open ring portion is configured with a first open ring portion whose center is located outside an end face of the yoke in a circumferential direction and a second open ring portion which is connected to the first open ring portion and whose center overlaps he end face, and
a center of the pillar portion overlaps the end face of the yoke in the circumferential direction.

20. A rotating electrical machine comprising:
a stator according to claim 13;
a rotor coaxially disposed on a side of an inner peripheral face of the stator; and
a housing holding the stator and including a bearing to support the rotor rotatably.

21. A rotating electrical machine comprising:
a stator according to claim 14;
a rotor coaxially disposed on a side of an inner peripheral face of the stator; and
a housing holding the stator and including a bearing to support the rotor rotatably.

22. A rotating electrical machine comprising:
a stator according to claim 15;
a rotor coaxially disposed on a side of an inner peripheral face of the stator; and
a housing holding the stator and including a bearing to support the rotor rotatably.

23. A rotating electrical machine comprising:
a stator according to claim 16;
a rotor coaxially disposed on a side of an inner peripheral face of the stator; and
a housing holding the stator and including a bearing to support the rotor rotatably.

24. A rotating electrical machine comprising:
a stator according to claim 17;
a rotor coaxially disposed on a side of an inner peripheral face of the stator; and
a housing holding the stator and including a bearing to support the rotor rotatably.

25. A rotating electrical machine comprising:
a stator according to claim 18;
a rotor coaxially disposed on a side of an inner peripheral face of the stator; and
a housing holding the stator and including a bearing to support the rotor rotatably.

26. A rotating electrical machine comprising:
a stator according to claim 19;
a rotor coaxially disposed on a side of an inner peripheral face of the stator; and
a housing holding the stator and including a bearing to support the rotor rotatably.

27. A manufacturing method for a stator comprising:
forming each of a plurality of core piece members by covering a magnetic material part with insulators, the magnetic material part being formed such that a yoke extending in an arc shape and a tooth protruding from the yoke toward a rotation axis are formed;
forming a coupling part having a fitting structure between the core piece members adjacent to each other in arranging a plurality of the core piece members such that the teeth are directed to the same side and end faces of the yokes in the circumferential direction are arranged to face each other, the coupling part allowing rotation about a pillar portion and restricting displacement in the axis direction by a snap-fit coupling in which the pillar portion being provided in a yoke part of one of the core piece members and extending in a direction parallel to the axis is fitted into an open ring portion being provided with a gap between the open ring portion and the magnetic material part in the axis direction in the yoke part of other of the core piece members;
forming a coil by winding a wire around each tooth in each of a plurality of the core piece members connected by the coupling part with an angle between the teeth of the core piece members adjacent to each other widened; and
connecting the core piece members having the coils formed thereon in a ring shape with the teeth directed inward, wherein
the pillar portion is provided so as to extend from a base portion having a larger diameter than the pillar portion, and
the base portion of one of the core piece members is inserted into the gap of the other of the core piece members when the snap-fit coupling is formed.

28. A manufacturing method for a stator comprising:
forming each of a plurality of core piece members by covering a magnetic material part with insulators, the magnetic material part being formed such that a yoke extending in an arc shape and a tooth protruding from the yoke toward a rotation axis are formed;
forming a coil by winding a wire around each tooth in each of a plurality of the core piece members; and
connecting the core piece members in a ring shape with the teeth directed inward after forming a coupling part having a fitting structure between the core piece members adjacent to each other in arranging a plurality of the core piece members having the coils formed thereon such that the teeth are directed to the same side and end faces of the yokes in the circumferential direction are arranged to face each other, the coupling part allowing rotation about a pillar portion and restricting displacement in the axis direction by a snap-fit coupling in which the pillar portion being provided with a gap between the open ring portion and the magnetic material part in the axis direction in a yoke part of one of the core piece members and extending in a direction parallel to the axis is fitted into an open ring portion being provided in the yoke part of other of the core piece members, wherein
the pillar portion is provided so as to extend from a base portion having a larger diameter than the pillar portion, and
the base portion of one of the core piece members is inserted into the gap of the other of the core piece members when the snap-fit coupling is formed.

29. A manufacturing method for a rotating electrical machine comprising:
forming the stator by the manufacturing method for the stator according to claim 27; and
coaxially disposing a rotor rotatably on a side of an inner peripheral face of the formed stator.

30. A manufacturing method for a rotating electrical machine comprising:
forming the stator by the manufacturing method for the stator according to claim 28; and
coaxially disposing a rotor rotatably on a side of an inner peripheral face of the formed stator.
